(19) United States
(12) Patent Application Publication
(10) Pub. No.: US 2022/0251313 A1
(43) Pub. Date: Aug. 11, 2022

(54) POLYURETHANE-BASED COMPOSITION

(71) Applicant: Dow Global Technologies LLC, Midland, MI (US)

(72) Inventors: Luca Lotti, Correggio (IT); Rainer Koeniger, Horgen (CH); Paolo Diena, Modena (IT); Enrico Baggio, Correggio (IT); Guido Bramante, Tarragona (IT); Lorenzo Musiani, Correggio (IT)

(21) Appl. No.: 17/597,510

(22) PCT Filed: Jul. 29, 2020
(86) PCT No.: PCT/US2020/043960

§ 371 Date: Jan. 10, 2022

(30) Foreign Application Priority Data
Aug. 1, 2019 (IT) 1020190000013701

(51) Int. Cl. C08J 5/04; C08G 18/24; C08G 18/32; C08G 18/08

(52) U.S. Cl. CPC C08J 5/046; C08G 18/242; C08J 2375/00; C08G 18/0838; C08G 18/3203

(57) ABSTRACT

A composition for producing a fiber-reinforced polyurethane composite product including: (I) a reactive mixture of: (a) at least one polyisocyanate; (b) at least one polyol, and (c) at least one tin (IV)-based catalyst; and (II) at least one fibrous material; and a fiber-reinforced polyurethane composite product produced from the above composition.

### FIELD

The present invention relates to a polyurethane-based composition; a fiber-reinforced polyurethane composite made from the polyurethane-based composition, and a process for producing the fiber-reinforced polyurethane composite.

### BACKGROUND

Unsaturated polyester resins are known reaction products of alpha-beta ethylenically unsaturated dicarboxylic acids of anhydrides thereof with at least one polyhydric alcohol (ordinarily a dihydric alcohol, i.e., a glycol). The most common thermoset formulations for producing a reinforced composite using low-pressure, room-temperature cure, resin transfer molding methods are unsaturated polyester resins (UPR). Other thermoset formulations used for producing a reinforced composite include polyurethane (PU) resins. PU resins are known reaction products of a polyisocyanate component with a blend of an isocyanate-reactive compound, catalyst, and other additives. However, a low-pressure, room-temperature cure, resin transfer molding method is seldom used to prepare a composite from a PU-based composition due to various important advantages provided by UPR thermoset formulations commonly used in this field of application.

Low-pressure, room-temperature cure resin transfer molding methods, include methods performed at a pressure of, for example, 1 bar to 5 bars of injection pressure measured in an injection hose; and performed at a cure temperature of room temperature (about 25° C.). The above resin transfer methods known in the art include, for example, a RTM-Light (resin transfer molding-Light) method, a RTM-Lite (resin transfer molding-Lite) method, or a low-pressure resin transfer molding (LRTM) method. All of above RTM methods collectively will herein be referred to as LRTM.

UPR thermosets, which are known to cure via radical crosslinking, are important for use in LRTM processes, because the UPR materials display a so-called “latent” curing profile, that is, the viscosity of a liquid blend of the resin including curatives increases over time in a very quick way even if the parts of the LRTM process (molds, reinforcing fibers, reactive mixture and the like) are at room temperature. Latency of curing is advantageous because an initial uncured low viscosity of the reactive mixture allows the use of long infusion times (i.e., the period of time the reactive mixture is being infused into reinforcing fibers) leading to parts with good and homogeneous impregnation of reinforcement fibers with resin. On the other hand, a subsequent fast cure of reactive mixture to form a composite allows a short demolding time of the formed composite, with the consequence of shortening the cycle time of part production made from the composite, which in turn, increases production efficiency and reduces production costs.

An important ingredient in a PU-based composition for making the fiber-reinforced polyurethane composites includes the catalyst. There is a plethora of catalysts and mixtures of catalysts known in the art that are useful for making fiber-reinforced PU composites and PU foams. However, not all catalysts that work for making PU foams will work for making PU composites and vice versa; and/or not all catalysts that work for making PU foams will work for making other non-PU systems such as polysiloxanes. In particular, known tin-based catalysts, such as FOMREZ® UL-54 (Me₂SnTg₂), FOMREZ® UL-6 (Bu₂SnTg₂), and FOMREZ® UL-29 (Oc₂SnTg₂; FOMREZ is a trademark of Chemtura Corporation), are commonly used, for example, in compositions for making foams (for example, methyl [Me], n-butyl [Bu], n-octyl [Oc]; tin (IV) is equal to (=) Sn; and 2-ethylhexyl mercaptoacetate [Tg]). Exemplary tin-based catalysts used for making foam are described in U.S. Pat. Nos. 2,801,231; 3,073,788; 3,635,906; 4,101,471; 4,173,692; and 6,107,355.

Typically, a pultrusion process is used to produce a fiber-reinforced PU-based composite as described in U.S. Patent Application Publication No. US2006/0173128A1, WO2013127850 (A1) and WO2012150218 (A1). However, it is desirous to provide a PU-based formulation or composition for making a fiber-reinforced PU-based composite via a LRTM process, wherein the PU-based composition includes a certain class of catalytic compounds that allows the PU-based composition to be used in a LRTM process to make a fiber-reinforced PU-based composite.

### SUMMARY

The present invention relates to a polyurethane (PU)-based formulation or composition for making a fiber-reinforced polyurethane-based (herein abbreviated as “FRPU”) composite, wherein the PU-based composition includes a certain class of catalytic compounds that advantageously provides a catalyzed PU-based composition useful for making a FRPU composite via a low-pressure (e.g., from 1 bar to 5 bars measured during the injection step of the process), room temperature cure (e.g., from 18° C. to 25° C.) resin transfer molding process (e.g., RTM-Light, RTM-Lite, or LRTM). The resulting FRPU composite made by a low-pressure, room temperature cure resin transfer molding process is a FRPU composite that constitutes a bubble-free compact polymer matrix with fibers embedded therein.

Some of the advantages of the present invention include, for example: (1) the composition of the present invention is a PU-based composition that can be used to make a FRPU; (2) a LRTM process can be used to make the FRPU composite from the PU-based composition; (3) the use of a certain class of tin (IV)-based compounds added to the PU composition surprisingly enables the PU composition to fully impregnate the reinforcement fiber (infusion process) without any dry fiber in the final composite part; (4) the infusion process can be performed for a relatively long time (e.g., from 1 minute [min] to 15 min) and then the curing of the infused fiber (after the infusion process) can occur at a relatively fast time (e.g., from 15 min to 60 min); (5) an easy and quick impregnation of reinforcement fibers can be performed; (6) the formulation initially has a low-viscosity (e.g., below 1,000 millipascals-seconds (mPa·s) in one embodiment and below 400 mPa·s in another embodiment) and the initial viscosity of the composition can remain low (e.g., below 1,000 mPa·s) for a good amount of time such as longer than or equal to the infusion time (e.g., from 1 min to 15 min); and (7) the resulting FRPU composite, made from the composition of the present invention, has a fast demolding time (e.g., from 15 min to 60 min) after the end of the infusion process (e.g., from 1 min to 15 min); (8) the cycle times for making FRPU composite parts made from the PU composition of the present invention is fast and economical; and (9) all of the above items (1)-(8), i.e., the process and property measurements, can be carried out at about room temperature (e.g., from 18° C. to 25° C.) as opposed to higher temperatures than room temperature.

In addition, the novel PU-based composition of the present invention which includes a tin (IV)-based catalyst such as thioglycolate ester, and the FRPU composite made using the PU-based composition and LRTM process in accordance with the present invention, provides a FRPU composite comparable to conventional fiber-reinforced UPR-based composites in terms of reaction profile overtime and mechanical properties.

In one embodiment, the present invention is directed to a PU-based composition (or formulation) for producing a FRPU composite product, wherein the PU-based composition includes:

(I) a polyurethane-forming reactive mixture of:
(a) at least one polyisocyanate;
(b) at least one polyol; and
(c) at least one tin (IV)-based catalyst, wherein the at least one tin (IV)-based catalyst is an alkyl tin (IV) thioglycolate ester catalyst; and

(II) at least one fibrous material;
wherein the viscosity of the composition increases over time such that the ratio of A:B for the composition is less than 4.5; wherein A is the time needed for the composition to reach a viscosity of 10⁶ mPa·s and B is the time needed for the composition to reach a viscosity of 1,000 mPa·s.

In another embodiment, the present invention includes a process for producing the above PU-based composition, which in turn, is useful for producing a FRPU composite product.

In still another embodiment, the present invention includes a process for producing a FRPU composite product comprising, after the PU-based composition is prepared as described above, allowing the PU composition to react such that, upon reaction of the PU composition, a FRPU composite product is produced.

In yet another embodiment, the present invention includes a FRPU composite product produced by the above process.

### BRIEF DESCRIPTION OF THE DRAWINGS

FIG. 1 is a graphical illustration showing time to 1,000 mPa·s and time to 10⁶ mPa·s of various polyurethane-based compositions with varying concentrations of catalysts.

FIG. 2 is another graphical illustration showing time to 1,000 mPa·s and time to 10⁶ mPa·s of various polyurethane-based compositions with varying concentrations of catalysts.

### DETAILED DESCRIPTION

A “PU” resin herein means a polyurethane resin, intended as the polymer obtained by reacting, for example, a polyisocyanate and isocyanate-reactive compounds such as polyols.

A “FRPU” composite herein means a fiber-reinforced PU-based composite.

In a broad embodiment, the composition or formulation of the present invention includes (I) a reactive mixture of the following components: (I)(a) a polyisocyanate; (I)(b) a polyol, and (I)(c) a tin (IV)-based catalyst; and (II) a fibrous material. Other optional components can be added to the above composition if desired. The reactive mixture (I) of components (I)(a), (I)(b) and (I)(c) forms the resulting reactive composition, component (I) that, once mixed together and infused into the reinforcement fibrous material, component (II), reacts to form a FRPU thermoset composite. Before the reactive composition reacts, the composition is transferred to a mold containing the reinforcement fiber, component (II); and after a period of time, the composition eventually reacts having the reinforcement fiber embedded in the composition which results in a FRPU composite.

U.S. Pat. No. 5,973,099 describes two macromolecular structures: (one classified in the cited patent as an “inventive example”, and one classified in the cited patent as a “comparative example” typical of the art). The two macromolecular structures are both adequate for preparing PU-based composites via LRTM. In a preferred embodiment, the components used for preparing the reactive polyurethane composition of the present invention can be any one or more of the components described in U.S. Pat. No. 5,973,099 except that the delayed action catalysts disclosed in the above patent is replaced with the tin (IV) thioglycolate ester catalyst of the present invention. Advantageously, the compositions of the present invention unexpectedly exhibit an improvement in terms of latency with the use of the tin (IV) thioglycolate ester catalyst of the present invention.

The polyisocyanate of the present invention can include one or more polyisocyanate compounds including for example aliphatic and cycloaliphatic and preferably aromatic polyisocyanates or combinations thereof, advantageously having an average of from 2 to 3.5, and preferably from 2.4 to 3.2 isocyanate groups per molecule. A crude polyisocyanate may also be used in the practice of the present invention, such as crude toluene diisocyanate obtained by the phosgenation of a mixture of toluene diamine or the crude diphenylmethane diisocyanate obtained by the phosgenation of crude methylene diphenylamine. The preferred polyisocyanates are aromatic polyisocyanates such as disclosed in U.S. Pat. No. 3,215,652. Especially preferred are methylene-bridged polyphenyl polyisocyanates and mixtures thereof with crude diphenylmethane diisocyanate, due to their ability to cross-link the polyurethane, commonly called by those skilled in the art polymeric methylenediphenyldiisocyanate (PMDI).

Exemplary available isocyanate-based products include PAPI™ products, ISONATE™ products, VORANATE™ products, VORASTAR™ products, HYPOL™ products, HYPERLAST™ products, and TERAFORCE™ Isocyanates products, all of which are available from The Dow Chemical Company.

The isocyanate-reactive component is mixed with the isocyanate component to provide a reactive mixture having an isocyanate index from 70 to 350 (e.g., various embodiments of the isocyanate index include from 80 to 300, from 90 to 250, from 90 to 200, from 90 to 180, from 100 to 170, and the like.). The isocyanate index is measured as the equivalents of isocyanate in the reaction mixture for forming the polyurethane network, divided by the total equivalents of isocyanate-reactive hydrogen containing materials in the reaction mixture, multiplied by 100. Considered in another way, the isocyanate index is the ratio of isocyanate-groups over isocyanate-reactive hydrogen atoms present in the reaction mixture, given as a percentage.

In other embodiments, the polyisocyanate of the present invention is present in the reactive mixture (I) of components (I)(a), (I)(b) and (I)(c) in an amount allowing the isocyanate index to be, for example, between 70 and 140 in one embodiment, between 80 and 130 in another embodiment, and between 90 and 120 in still another embodiment.

The polyol of the present invention can include one or more polyol compounds including for example polyols selected from the group of a polyether polyol, a polyester polyol, a polycarbonate polyol, a natural-oil derived polyol, and/or a simple polyol (such as glycerin, ethylene glycol, propylene glycol, butylene glycol); and mixtures thereof. For example, the one or more polyols may include one or more polyether polyols and/or one or more polyester polyols. The polyether polyols may be prepared, for example, by the polymerization of epoxides, such as ethylene oxide, propylene oxide, and/or butylene oxide. The one or more polyols may have a hydroxyl number from 50 milligrams of potassium hydroxide per gram of polyol (mg KOH/g) to 700 mg KOH/g in one embodiment and from 80 mg KOH/g to 680 mg KOH/g in another embodiment.

In some embodiments, the polyol component can include, for example, any one or more of the following polyol blends comprising:

(1) 15 weight percent (wt %) to 80 wt % (based on the sum of components (I)(a) polyisocyanate, (I)(b) polyester polyol and (I)(c) tin (IV)-based catalyst of polyesters) of fatty acids including, for example, alcohol molecular units in the chain (e.g., 40 wt % of Castor Oil);

(2) 20 wt % to 85 wt % (based on the sum of the above components (I)(a), (I)(b) and (I)(c)) of crosslinking polyols (e.g., short-chain propylene-oxide based triols) having a functionality of, for example, from 3 to 8 in one embodiment; and having a relatively low molecular weight (Mw) of, for example, from 92 Daltons (Da) to 1,000 Da in one embodiment; and

(3) from 20 wt % to 60 wt % (based on the sum of components (I)(a), (I)(b) and (I)(c)) of a long chain triol (having a Mw of, for example, from 1,000 Da to 10,000 Da) or a diol (having a Mw of, for example, from 62 Da to 10,000 Da) or a mixture thereof.

The tin (IV)-based catalyst of the present invention can include one or more catalyst compounds including for example alkyl-tin (IV) thioglycolate esters. In one embodiment, the thioglycolate ester catalyst can be a catalyst having the following general chemical structure:

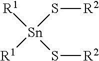

where R¹ is an alkyl group such as methyl, n-butyl, iso-octyl, n-octyl and the like, and R² is
—CH₂COOR³, where R³ is an alkyl group such as methyl, iso-octyl, 2-ethylhexyl and the like.

It has been discovered that this type of organo-tin (IV) catalysts used in the reactive composition of the present invention can provide good latency when the composition is cured at room temperature, better than any other PU catalyst of common use such as a tertiary amine-based catalyst. For example, in one preferred embodiment, the catalyst useful in the present invention has the following chemical structure: R¹₂Sn(Tg)₂, where R¹ is an alkyl group having from 1 carbon atom (methyl) to 10 carbon atoms; and Tg is a thioglycolate ester moiety of the form R³OOC—CH₂—S⁻ where R³ is an alkyl group having from 1 carbon atom (methyl) to 10 carbon atoms. The thioglycolate ester moieties are bonded to the tin (IV) metal center of the complex through the atom of sulfur, carrying the negative charge. In one embodiment, the catalyst (I)(c) is pre-blended in the polyol component (I)(b) described above.

In another preferred embodiment, the tin (IV)-based catalyst compound can include commercially available compounds such as FOMREZ®-class catalysts FOMREZ® UL-54 (dimethyl tin (IV) di(2-ethylhexyl)thioglycolate), FOMREZ® UL-6 (di-n-butyl tin (IV) di(2-ethylhexyl)thioglycolate), FOMREZ® UL-29 (di-n-octyl tin (IV) di(2-ethylhexyl)thioglycolate, all available from Galata Chemicals), and mixtures thereof.

The amount of tin (IV)-based catalyst compound based on the sum of (I)(b) and (I)(c) used in the reactive composition of the present invention can be, for example, from 0.05 wt % to 0.10 wt % in one embodiment, from 0.15 wt % to 0.2 wt % in another embodiment and 0.4 wt % in still another embodiment. Above 0.4 wt %, typically the reaction times (e.g. the time needed to reach 1,000 mPa·s) are excessively fast (e.g. below 20 seconds [s]); and the reaction times do not allow the impregnation of parts which may be made in an infusion at longer than 20 s, so, virtually no reaction time of any length is provided. Infusion times vary between 1 min and 15 min. Below 0.05 wt % of catalyst content based on the total of compounds (I)(b) and (I)(c), almost no difference will be noticed in the reactivity with respect to catalyst absence.

The reinforcing material, component (II), of the present invention can include one or more fibrous materials including for example fibrous mats and sheets that are placed in the mold before the reactants are injected into the mold; and/or known fillers and/or reinforcing substances that are introduced in admixture with one of the reactants (generally the isocyanate-reactive component). Examples of suitable materials from which suitable mats or sheets can be made include natural fibers such as burlap, jute, and coconut and synthetic fibers such as glass fibers, basalt fibers, polypropylene fibers, nylon fibers, polyester fibers, aramid fibers, liquid crystal fibers, and carbon fibers. Examples of other suitable fillers and/or reinforcing substances include barium sulfate, calcium carbonate, talc, Wollastonite, hydrated alumina, clay, kieselguhr, whiting, mica, in organic or organic microspheres, glass flakes, glass fibers (preferably milled glass fibers), liquid crystal fibers, nylon fibers, aramide fibers, polyester fibers and carbon fibers. In general, the reinforcing materials can be oriented strands, random strands, chipped strands, rovings, or any other suitable form or combination of the previous forms, including alternating layers of various reinforcing materials or various fiber arrangement (oriented strands, random strands, chipped strands, rovings, or any other suitable form). The reinforcing materials may be used in quantities of up to about 50% by volume (preferably up to 25% by volume) based on the total volume of the FRPU composite.

In one preferred embodiment, the fibrous material can include glass fibers, basalt fibers, carbon fibers and mixtures thereof.

In another preferred embodiment, the fibrous material can include commercially available compounds such as Multicore® which is a sandwich material comprising a propylene fiber sandwiched between two glass fiber layers with alternating layers (available from Owens Corning Inc.).

The amount of fibrous material used in the reactive composition of the present invention can be, for example, from 5 volume percent (vol %) to 50 vol % in one embodiment, from 15 vol % to 40 vol % in another embodiment and 15 vol % to 35 vol % in still another embodiment. Above 50 vol %, it would be difficult for the reactive mixture to properly infuse the fiber unless higher injection pressures are used (but typical molds used in LRTM cannot withstand more than 1 bar to 2 bars of internal pressure before being destroyed/opened during the reactive mixture injection). Below 5 vol %, the amount of fiber would be so low that the compound would not benefit from the presence of the fiber and the resulting FRPU composite part would not show mechanical properties remarkably better compared to a composite part without fiber-reinforcement.

In addition to the above components in the reactive mixture, component (I), the reactive mixture may also include other additional optional compounds or additives; and such optional compounds may be added to the reactive mixture with any one or more of the components (I)(a), (I)(b) and (I)(c); or as a separate addition. The optional additives or agents that can be used in the present invention can include one or more various optional compounds known in the art for their use or function. For example, the optional additives, agents, or components can include internal mold release agents, lubricants, flame retardants, surface-active additives, pigments, dyes, UV stabilizers, plasticizers, and fungistatic or bacteriostatic substances, external release agents, internal release agents, and mixtures thereof. External release agents, such as silicone oils, can be used instead of, or in addition to, internal release agents.

As an optional compound, titanium dioxide is taken as an example as this solid mineral gives an aesthetically pleasant white color to the FRPU composite. A preferred grade of titanium dioxide is named REPI White 11114 (available from company REPI SpA, Italy) and it is a suspension of the mineral in a long-chain polyol of proprietary composition. The amount of optional compound used, when added to the isocyanate-reactive blend of components (I)(b) and (I)(c) of the present invention, can be for example, from 0 wt % to 20 wt % in one embodiment, from 1 wt % to 5 wt % in another embodiment, and from 2 wt % to 10 wt % in still another embodiment.

A broad embodiment of a process of producing a PU formulation useful for forming a FRPU composite via LRTM includes, for example thoroughly mixing: (I) a reactive mixture having the following components: (I)(a) a polyisocyanate, (I)(b) a polyol, and (I)(c) a tin (IV)-based catalyst; wherein the reactive mixture (I) can be processed via equipment and techniques used for a resin transfer molding method; and (II) at least one fibrous material . In resin transfer molding, the components of step (I) described above are injected, under low pressure, into the mold, in which the reinforcement fiber (II) is present. For example, injection pressures for resin transfer molding are typically low pressures ranging from 10 psi to 50 psi (from 0.7 bar to 3.5 bars). Consequently, high pressure equipment is not needed in this context and advantageously it is possible to use less sophisticated injectors and metering machines, simpler molds, and smaller mold clamps for resin transfer molding. Also, injection times for resin transfer molding are typically from 1 min to 15 min, and gel times when using resin transfer molding are typically measured in minutes.

In a preferred embodiment the components are mixed at room temperature by means of a three-component low-pressure (e.g. below 10 bars of circuit pressure) metering equipment. The amount of the catalyst (I)(c) to be mixed with (I)(a) and (I)(b) should be decided based on the estimated infusion time and consequently on the desired reactivity of the reactive mixture, as those skilled in the art may understand.

The mixing of the three components to form the reactive mixture (I) can be carried out, for example, at a pressure of from 1 bar to 10 bars in one embodiment, from 1 bar to 8 bars in another embodiment, and from 1 bar to 6 bars in still another embodiment.

If desired, the following optional step(s) can be used to make the PU formulation composition: if a two-component metering machine is used, component (I)(c) may be pre-mixed with component (I)(b) before filling the tank/line of the metering machine. The amount of component (I)(c) to be pre-blended with component (I)(b) should be decided based on the estimated infusion time and consequently on the desired reactivity of the reactive mixture, as those skilled in the art may understand.

One advantageous property exhibited by the resulting PU-based composition produced according to the above described process includes a low ratio between selected critical viscosity times, or, in other words, a particularly steep viscosity increase overtime. A “critical viscosity time” is a time necessary for the reactive mixture to reach a certain viscosity, and critical viscosity time is measured in seconds; critical viscosity time is described in ASTM D4473-2008 and is known to those skilled in the art. Certain critical viscosity times are important as the critical viscosity times define the processing window; for example, time to 1,000 mPa·s defines the time for which the infusion of a reactive mixture can be carried out in a LRTM process safely, i.e., without moving the fibers inside the mold and completing the impregnation of the fibers with the reactive mixture without dry fibers being present in the final composite part. Other critical viscosity times may be used to understand the curing performance/rate of a thermoset material, e.g., time to 10⁹ mPa·s or time to 10⁶ mPa·s. The PU-based composition of the present invention allows systems to display particularly low ratios between these critical viscosity times; for example, the ratio between time to 10⁶ mPa·s and time to 1,000 mPa·s of the compositions of the present invention is below a ratio of 4.5.

The process of producing a FRPU composite product is carried out by a chemical reaction. When carrying out the process of the present invention, the polyurethane-forming reaction components (that is, the polyisocyanate, isocyanate-reactive compounds, catalyst, and any other materials such as additives and auxiliaries used in the present invention) are reacted using a resin transfer molding process and equipment. Polyurethanes produced according to the present invention may be prepared by introducing the reaction mixture into a suitable mold made, for example, from metals (such as aluminum or steel) or plastics (such as unsaturated polyester resin or epoxide resin); and the reinforcement fiber is usually placed inside the mold before the introduction of the reaction mixture itself into the mold.

In a general embodiment, the process for producing a FRPU composite of the present invention includes a low-pressure, room temperature cure resin transfer molding such as a LRTM method. The process includes mixing, at room temperature, the following components: (I)(a) a polyisocyanate; (I)(b) a polyol, and (I)(c) a tin (IV)-based catalyst and other optional components that can be added to the composition if desired to form a reactive mixture; and (II) the reinforcement fiber. Once the above reactive mixture is prepared, the reactive mixture is transferred to a mold which contains the fiber-reinforcement material. The above components are mixed such that the resulting reactive composition including the above components, once mixed together, react inside the mold with the reinforcement fiber to form a FRPU thermoset composite inside the mold.

The mold may or may not be evacuated after the placement of the fiber reinforcement, component (II) in the mold itself and before the injection of the reactive mixture, component (I), into the mold; the infusion of the fiber with the reactive mixture, component (I), will occur in an easy way if reduced pressure (e.g., from −0.01 to −0.99 bars; negative pressure is taken with respect to a condition of 0 bars=room conditions, i.e. atmospheric pressure) is applied to the mold cavity by means of a vacuum pump, vacuum hoses and a vacuum vent, and this represents a preferred embodiment of the present invention.

In the above preferred embodiment, the mold is closed after the fiber, component (II), placement, and sealed by means of silicone gaskets. Then, vacuum is applied to the mold by means of a vacuum pump. After some time has elapsed, the reactive mixture (I) (mixture of components (I)(a), (I)(b), (I)(c), and any other optional compounds) of the thermoset is injected in the mold cavity containing the reinforcement fiber, component (II), and the reactive mixture, component (I), impregnates the fiber. Impregnation speed depends on several aspects, one of which is the viscosity of the reactive mixture itself (the lower the viscosity, the faster the impregnation will be). The time for which impregnation or infusion occurs is called “infusion time”. Typical infusion times vary between 30 s and 15 min, but for very large parts infusion times can reach 30 min or hours. After some time has elapsed, the material is cured/reacted, the mold can be opened and the composite part removed from the mold (“demolding”).

The low-pressure resin transfer molding (LRTM) method is an economical method often practiced by artisans wherein the mold is often non-heatable. It is generally known that heat automatically lowers initial viscosities of reactive mixtures and shortens curing times of such mixtures regardless of the nature of the mixtures (e.g., polyurethane, epoxy, UPR, and the like). And, to accommodate heating, the mold has to be properly engineered, which can be expensive. On the other hand, molds which are commonly used in the LRTM process are often made from the same thermoset composites themselves; and do not require high temperatures and high-pressure equipment.

For encouraging an easy demold of the composite part after the curing, a demolding agent common in the art can be used, like waxes dispersed in low molecular weight hydrocarbons. The waxes are sprayed/poured and then dispersed with a cloth on the mold surface before putting the reinforcing fiber in the mold itself and performing the infusion. The demolding agent includes, for example, an external demolding agent such as ACMOS 37-7009 (commercially available from ACMOS Chemie KG; see the Examples described herein).

Inventive Examples and Comparative Examples of the present invention described herein below are carried out to: (1) test for the reactivity profile of reactive mixtures overtime with a rheometer according to ASTM D4473-2008 and by determining critical viscosity times such as time to reach 1,000 mPa·s, 10⁶ mPa·s, and 10⁹ mPa·s; and (2) make composite panels having the following dimensions: 700 mm x 700 mm square panel with a thickness of 3 mm Composite panels are successfully demolded in expected times when the formulations of the present invention contain the thioglycolate ester catalysts (I)(c) described heretofore.

In a preferred embodiment, the FRPU composite product of the present invention can be prepared by the following steps, entirely carried out at room temperature:

Step (1): a demolding agent is applied at ambient pressure on the LRTM mold surfaces;

Step (2): a fibrous material (II) is placed into the LRTM mold; the amount of fibrous material depends on the desired level of reinforcement needed in the FRPU composite, based on the final application as known by those skilled in the art;

Step (3): the LRTM mold is closed and sealed; typically, silicone gaskets are part of the LRTM mold and represent a preferred option for sealing the mold;

Step (4): vacuum is applied to the mold by means of a vacuum pump connected to the mold itself by means of hoses and a vacuum vent positioned in the mold itself;

Step (5): injection of the reactive mixture (I) including the components (I)(a) polyisocyanate, (I)(b) polyol, and (I)(c) tin (IV)-based catalyst, and any other optional components, if desired, is carried out at a certain pressure of injection not causing the mold to open/be destroyed during the injection itself. Typical values of injection pressure are 0.5 bar to 1 bar more than room pressure. Injection ends when the entirety of the reinforcement fiber (II) is wetted with the reactive mixture; at that point, the vacuum vent is closed and the vacuum pump is switched off;

Step (6): the reactive mixture is let cure for a certain amount of time in the mold; and

Step (7): after a certain cure time in the mold, the mold is opened and the FRPU composite piece is removed from the mold (“demolding”).

In another preferred embodiment, the FRPU composite product of the present invention can be prepared by adding one step before the introduction of the reinforcement fiber (II) (step (2) described above), and the additional step includes: applying to one or both sides of the mold a so called gel-coat. A “gel-coat” is a chemical composition used to give a pleasant aesthetic appearance to the FRPU composite part after the demolding/synthesis step, and the gel-coat is often pigmented to give a certain color to the composite part. Gel-coats are generally thermoset materials, and more specifically are often UPR systems. The gel-coats are first applied on mold surfaces by means of brushes or air-guns spraying systems, and then the applied gel-coat is allowed to cure for some time until final curing is reached. Using the above additional step, the process of producing the FRPU composite product of the present invention can be entirely carried out at room temperature as follows:

Step (1): one or more demolding agent is applied at ambient pressure on the LRTM mold surfaces; the use of a demolding agent allows an easy demolding depending on the material the demolding agent will come in contact with. Thus, if a gel-coat is applied (as described in Step (2) below), the demolding agent on the desired surface of the mold is a demolding agent for gel-coats such as PVA Mold Release (commercially available from EVERCOAT® Inc.)

Step (2): a gel-coat is applied to a desired mold surface by means of, for example, a compressed-air spray gun or a brush. The gel-coat is allowed a period of time to cure in the opened mold for a certain amount of time depending on the cure properties of the gel-coat itself;

Step (3): a fibrous material (II) is placed into the LRTM mold;

Step (4): the LRTM mold is closed and sealed;

Step (5): vacuum is applied to the mold by means of a vacuum pump;

Step (6): injection of the reactive mixture, is carried out until the entirety of the reinforcement fiber (II) is wetted with the reactive mixture; at that point, the vacuum vent is closed and the vacuum pump is switched off;

Step (7): the reactive mixture is allowed a period of time to cure for a certain amount of time in the mold; and

Step (8): after a certain cure time in the mold, demolding of the part is performed. The PU composition of the present invention exhibits excellent adhesion to UPR-based gel-coats.

Some of the advantageous properties exhibited by the resulting FRPU composite product produced according to the above described process, can include, for example: (1) a low ratio between a time to a high critical viscosity (e.g. time to 10⁶ mPa·s) and time to 1,000 mPa·s measured according to ASTM D4473-2008. This ratio quantifies the curing speed of the system, and gives a rough indication of the ratio demolding time/maximum infusion time, two important process parameters for LRTM as known by those skilled in the art; and (2) an excellent adhesion to UPR-based gel-coats, when these gel-coats are pre-reacted/cured in the mold before operating the LRTM process.

The FRPU composite product produced by the process of the present invention can be used, for example: (1) in machinery applications such as a cover part for equipment (e.g., agricultural machines or tractors, nautical motors/engines, automotive parts like engine covers, and the like); or as semi-structural parts in vehicles (e.g., boats, caravans, trucks, utility vehicles, and the like).

### EXAMPLES

The following examples are presented to further illustrate the present invention in detail but are not to be construed as limiting the scope of the claims. Unless otherwise indicated, all parts and percentages are by weight.

Various ingredients, components or raw materials used in the Inventive Examples (Inv. Ex.) and the Comparative Examples (Comp. Ex.) which follow are explained in Table I.

### Rheological Tests

Several formulations including various catalysts were tested, in a rheometer according to ASTM D4473-2008. Some of the Examples used in the present invention are based on the examples described in U.S. Pat. No. 5,973,099, except that one difference is the catalyst described in the above patent is substituted with the catalysts of the present invention or with other comparative catalysts as described herein. For instance, “Example 1” and “Example 2” described in U.S. Pat. No. 5,973,099 (that is, “Example 1” and “Example 2” in the cited patent are referenced as comparative examples in the cited patent) were used.

All the tests were done at 25° C. to simulate the LRTM process, which is typically carried out in a non-heated environment. All the tin-based catalysts and the reference catalysts tested provided some activity; and more specifically, all the reactive mixture formulations in the rheometer had a viscosity increase until a solid, non-foamed disk was produced.

The catalytic activity in the formulations was quantified by means of a rheometer that measured: (i) cinematic viscosity (η) overtime for viscosities values<1,000 mPa·s; and

(ii) modulus of the complex viscosity (|η*|) overtime otherwise. The purpose of this variation in test method is for maximizing signal/noise ratio, and have a good quality measurement.

A good method to quantify the latency of the catalyst is to report on the two axis of a chart two “times to critical viscosities” as described in ASTM D4473-2008.

A first important critical time is the time to reach 1,000 mPa·s (1 Pa·s). In the LRTM process the infusion of reinforcing fiber, which occurs under vacuum, ends when the reactive mixture reaches a viscosity of about 1,000 mPa·s; afterward, the viscosity is very high and the permeation becomes difficult.

With polyurethane, is it a common observation that in a rheometric chart the linearity of growth, in a Log(viscosity) chart vs time, is maintained until the viscosity reaches a value of about 10⁶ mPa·s; after this value, in general the slope of growth becomes inferior till the value of 10⁹ mPa·s, a value that may be used to roughly estimate a demolding time.

TABLE I
Chemical Agents Used in Examples

| Chemical | Brief Description | Function | Supplier |
|---|---|---|---|
| Polyol (P1) | A propoxylated glycerine with an equivalent weight (EW) of | Isocyanate reactive compound | The Dow Chemical |
| | 84.36 Da. | | Company (DOW) |
| Polyol (P2) | A propoxylated glycerine with an EW of 234 Da. | Isocyanate reactive compound | DOW |
| Polyol (P3) | A polypropylene oxide with an EW of 510 Da. | Isocyanate reactive compound | DOW |
| Polyol (P4) | A trimethylolpropane propoxylated with an EW of 59.05 Da. | Isocyanate reactive compound | Expanded Polymer, |
| | | | Inc., India |
| Polyol (P5) | Castor Oil with an EW of 344.17 Da. | Isocyanate reactive compound | TCC Inc |
| TEP | Triethyl phosphate (TEP). TEP does not react with isocyanates. | Flame retardant | Eastman |
| DPG | Dipropylene glycol (DPG) with an EW of 67.27. | | DOW |
| TPG | Tripropylene glycol (TPG) with an EW of 96.06 | | DOW |
| BYK-A 535 | An antifoam additive. | Antifoam | BYK Company |
| Water Scavenger | A blend, 50/50 wt % of Castor Oil and dried zeolite, with an | Water Scavenger | DOW |
| | average EW of 660 Da. | | |
| Isocyanate (g) | An oligomer of methylenediphenyldiisocyanate (PMDI) with | | DOW |
| | an average EW of 131.45 Da. | | |
| DABCO SA2LE | A blocked diazabicycloundecene delayed catalyst that becomes | Catalyst (C1) | Air Products |
| | latent at 80° C. | | |
| DABCO KTM60 | A blocked diazabicyclooctane delayed catalyst that becomes | Catalyst (C2) | Air Products |
| | latent at 60° C. | | |
| BiCat 8 | A catalyst based on bismuth carboxylates. | Catalyst (C3) | The Sheperd |
| | | | Chemical Company |
| KKAT-XK604 | A catalyst based on aluminum carboxylates. | Catalyst (C4) | King Industries |
| FOMREZ ® UL-38 | A tin (IV)-based catalyst* of the form Oc₂SnRCOO₂ where | Catalyst (C5) | Galata Chemicals |
| | RCOO = neodecanaote. | | (Galata) |
| DABCO T12N | A tin (IV)-based catalyst* of the form Bu₂SnRCOO₂ where | Catalyst (C6) | Air Products |
| | RCOO = laurate. | | |
| FOMREZ ® UL-32 | A tin (IV)-based catalyst* of the form Oc₂SnRS₂ where | Catalyst (C7) | Momentive |
| | RS— = dodecylthio. | | |
| FOMREZ ® UL-54 | A tin (IV)-based catalyst* of the form Me₂SnTg₂. | Catalyst (I1) | Galata |
| FOMREZ ® UL-6 | A tin (IV)-based catalyst* of the form Bu₂SnTg₂. | Catalyst (I2) | Galata |
| FOMREZ ® UL-29 | A tin (IV)-based catalyst*of the form Oc₂SnTg₂. | Catalyst (I3) | Galata |
| ACMOS 37-7009 | A wax dispersed in a hydrocarbon. | Demolding agent | ACMOS Chemie KG |

Notes for Table I:
*The catalysts have the form R₂SnT₂ where R is an alkyl group chosen among methyl (Me), butyl (Bu) and octyl (Oct) groups, and T is another group chosen between: thioglycolate esters (herein “Tg”), carboxylates (herein “RCOO”), and mercaptides (herein “RS”).

The test results of formulations with different catalysts and at various levels are described in Tables II and Table III. Table II describes formulations which generally follow comparative examples 2, 4, 6, and 8 of U.S. Pat. No. 5,973,099, while Table III describes formulations which generally follow examples 1, 3, 5, 7 and 9-15 of U.S. Pat. No. 5,973,099. All the reactions were performed at 25° C.

TABLE II

| | Comp. | Comp. | Comp. | Comp. | Comp. | Comp. | Comp. | Inv. |
|---|---|---|---|---|---|---|---|---|
| | Ex. A | Ex. B | Ex. C | Ex. D | Ex. E | Ex. F | Ex. G | Ex. 1 |
| Ingredient | | | | | | | | |
| Polyol (P1) | 56.50 | 56.50 | 56.50 | 56.50 | 56.50 | 56.50 | 56.50 | 56.50 |
| Polyol (P2) | 23.50 | 23.50 | 23.50 | 23.50 | 23.50 | 23.50 | 23.50 | 23.50 |
| Polyol (P3) | 14.10 | 14.10 | 14.10 | 14.10 | 14.10 | 14.10 | 14.10 | 14.10 |
| Antifoam | 0.20 | 0.20 | 0.20 | 0.20 | 0.20 | 0.20 | 0.20 | 0.20 |
| Water Scavenger | 5.70 | 5.70 | 5.70 | 5.70 | 5.70 | 5.70 | 5.70 | 5.70 |
| TPG | — | — | — | — | — | — | — | 2.25 |
| Catalyst (C2) | 0.70 | — | — | — | — | — | — | — |
| Catalyst (C3) | — | 0.33 | — | — | — | — | — | — |
| Catalyst (C4) | — | — | 0.87 | — | — | — | — | — |
| Catalyst (C5) | — | — | — | 0.18 | — | — | — | — |
| Catalyst (C6) | — | — | — | — | 0.20 | — | — | — |
| Catalyst (C7) | — | — | — | — | — | 0.20 | 0.10 | — |
| Catalyst (I1) | — | — | — | — | — | — | — | 0.25 |
| Catalyst (I2) | — | — | — | — | — | — | — | — |
| Catalyst (I3) | — | — | — | — | — | — | — | — |
| Total Polyol | 100.70 | 100.33 | 100.87 | 100.18 | 100.20 | 100.20 | 100.10 | 102.50 |
| (parts by weight) | | | | | | | | |
| Property | | | | | | | | |
| Index | 105 | 105 | 105 | 105 | 105 | 105 | 105 | 105 |
| Isocyanate (g) | 111.3 | 111.3 | 111.3 | 111.3 | 111.3 | 111.3 | 111.3 | 114.5 |
| time to 1,000 | 192 | 103 | 195 | 193 | 127 | 69 | 189 | 99 |
| mPa · s (s) | | | | | | | | |
| time to 10⁶ | 2,775 | 1,509 | 2,912 | 1,012 | 615 | 633 | 1,306 | 458 |
| mPa · s (s) | | | | | | | | |
| Ratio of time | 14.5 | 14.7 | 14.9 | 5.2 | 4.8 | 9.2 | 6.9 | 4.5 |
| to 10⁶ mPa · s/ | | | | | | | | |
| time to | | | | | | | | |
| 1,000 mPa · s | | | | | | | | |

| | Inv. | Inv. | Inv. | Inv. | Inv. | Inv. | Inv. |
|---|---|---|---|---|---|---|---|
| | Ex. 2 | Ex. 3 | Ex. 4 | Ex. 5 | Ex. 6 | Ex. 7 | Ex. 8 |
| Ingredient | | | | | | | |
| Polyol (P1) | 56.50 | 56.50 | 56.50 | 56.50 | 56.50 | 56.50 | 56.50 |
| Polyol (P2) | 23.50 | 23.50 | 23.50 | 23.50 | 23.50 | 23.50 | 23.50 |
| Polyol (P3) | 14.10 | 14.10 | 14.10 | 14.10 | 14.10 | 14.10 | 14.10 |
| Antifoam | 0.20 | 0.20 | 0.20 | 0.20 | 0.20 | 0.20 | 0.20 |
| Water Scavenger | 5.70 | 5.70 | 5.70 | 5.70 | 5.70 | 5.70 | 5.70 |
| TPG | 1.80 | 1.35 | 0.90 | 0.45 | — | — | — |
| Catalyst (C2) | — | — | — | — | — | — | — |
| Catalyst (C3) | — | — | — | — | — | — | — |
| Catalyst (C4) | — | — | — | — | — | — | — |
| Catalyst (C5) | — | — | — | — | — | — | — |
| Catalyst (C6) | — | — | — | — | — | — | — |
| Catalyst (C7) | — | — | — | — | — | — | — |
| Catalyst (I1) | 0.20 | 0.15 | 0.10 | 0.05 | — | — | — |
| Catalyst (I2) | — | — | — | — | 0.20 | — | — |
| Catalyst (I3) | — | — | — | — | — | 0.30 | 0.20 |
| Total Polyol | 102.00 | 101.50 | 101.00 | 100.50 | 100.20 | 100.30 | 100.20 |
| (parts by weight) | | | | | | | |
| Property | | | | | | | |
| Index | 105 | 105 | 105 | 105 | 105 | 105 | 105 |
| Isocyanate (g) | 113.9 | 113.2 | 112.6 | 112.0 | 111.3 | 111.3 | 111.3 |
| time to 1,000 | 145 | 223 | 369 | 592 | 269 | 206 | 353 |
| mPa · s (s) | | | | | | | |
| time to 10⁶ | 568 | 679 | 1,077 | 1,766 | 850 | 691 | 1,060 |
| mPa · s (s) | | | | | | | |
| Ratio of time | 3.9 | 3.0 | 2.9 | 3.0 | 3.2 | 3.4 | 3.0 |
| to 10⁶ mPa · s/ | | | | | | | |
| time to | | | | | | | |
| 1,000 mPa · s | | | | | | | |

TABLE III

| | Comp. | Comp. | Comp. | Comp. | Comp. | Inv. | Inv. | Inv. | Inv. |
|---|---|---|---|---|---|---|---|---|---|
| | Ex. H | Ex. I | Ex. J | Ex. K | Ex. L | Ex. 9 | Ex. 10 | Ex. 11 | Ex. 12 |
| Ingredient | | | | | | | | | |
| Polyol (P1) | 25.00 | 25.00 | 25.00 | 25.00 | 25.00 | 25.00 | 25.00 | 25.00 | 25.00 |
| Polyol (P4) | 11.00 | 11.00 | 11.00 | 11.00 | 11.00 | 11.00 | 11.00 | 11.00 | 11.00 |
| Polyol (P5) | 41.80 | 41.80 | 41.80 | 41.80 | 41.80 | 41.80 | 41.80 | 41.80 | 41.80 |
| TEP | 4.00 | 4.00 | 4.00 | 4.00 | 4.00 | 4.00 | 4.00 | 4.00 | 4.00 |
| DPG | 4.00 | 4.00 | 4.00 | 4.00 | 4.00 | 4.00 | 4.00 | 4.00 | 4.00 |
| Antifoam | 0.20 | 0.20 | 0.20 | 0.20 | 0.20 | 0.20 | 0.20 | 0.20 | 0.20 |
| Water Scavenger | 14.00 | 14.00 | 14.00 | 14.00 | 14.00 | 14.00 | 14.00 | 14.00 | 14.00 |
| Catalyst (C1) | 0.40 | — | — | — | — | — | — | — | — |
| Additional DPG | — | 2.00 | 1.50 | 1.00 | 0.50 | — | — | — | — |
| Catalyst (C2) | — | 2.00 | 1.50 | 1.00 | 0.50 | — | — | — | — |
| TPG | — | — | — | — | — | 1.80 | 1.35 | 0.90 | 0.45 |
| Catalyst (I1) | — | — | — | — | — | 0.20 | 0.15 | 0.10 | 0.05 |
| Total Polyol | 100.4 | 104.0 | 103.0 | 102.0 | 101.0 | 102.0 | 101.5 | 101.0 | 100.5 |
| (parts by weight) | | | | | | | | | |
| Property | | | | | | | | | |
| Index | 110 | 110 | 110 | 110 | 110 | 110 | 110 | 110 | 110 |
| Isocyanate (g) | 100.6 | 104.3 | 103.2 | 102.1 | 101.0 | 102.6 | 102.0 | 101.3 | 100.6 |
| time to 10³ | 204 | n/a | 51 | 122 | 192 | 127 | 240 | 316 | 410 |
| mPa · s (s) | | | | | | | | | |
| time to 10⁶ | 2,236 | 300 | 541 | 1,334 | 1,838 | 361 | 593 | 844 | 1,119 |
| mPa · s (s) | | | | | | | | | |
| time to 10⁹ | 130 | — | — | 63 | 84 | 15 | 25 | 30 | 50 |
| mPa · s (min) | | | | | | | | | |
| Ratio of: time | 11.0 | — | 10.6 | 10.9 | 9.6 | 2.8 | 2.5 | 2.7 | 2.7 |
| to 10⁶ mPa · s/ | | | | | | | | | |
| time to | | | | | | | | | |
| 1,000 mPa · s | | | | | | | | | |

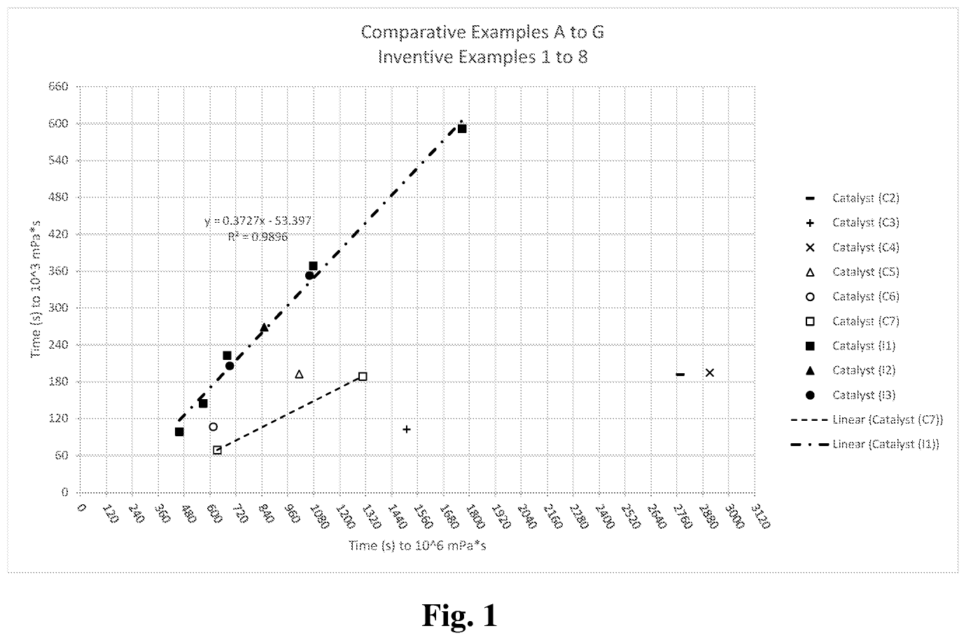

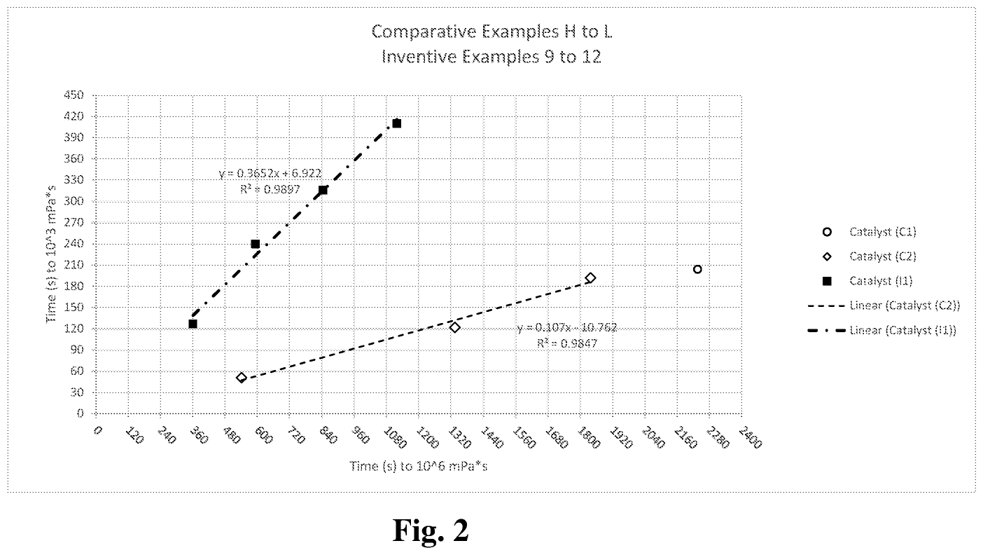

The data in Tables II and III show that Catalyst (I1), (I2) and (I3) behave in the same way as shown in the second chart of FIG. 2. When the concentration of the catalysts is varied, both the time to 1,000 mPa·s and the time to 10⁶ mPa·s also vary. However, in a regular and predictable way; the logarithmic regression reported in the first chart of FIG. 1 can enable a person skilled in the art to define a suitable catalyst concentration (Catalyst (I1), (I2), or (I3)) for use in a PU-based formulation in order to avoid the formulation gelling before the end of infusion time using the LRTM process.

Catalysts (C1-C7) do not provide the formulations with a high value of time to 1,000 mPa·s while at the same time, the catalysts do provide the formulations with a short value of time to 10⁶ mPa·s, which correlates to good latency.

### Composites

A 700 mm×700 mm×3 mm mold was used to prepare glass fiber/PU composites. The mold is made of: (1) (bottom) a sandwich-composite base layer, (2) silicone rubber sealings on the sides and partially embedded in the bottom sandwich structure, and (3) (top) a glass lid/cover that ensured vacuum resistance by closing on the sealing. The glass top cover enabled the operator to visually observe the PU matrix infusion, to visually detect possible defects and to track impregnation times. The mold, prior to use, was first pre-treated with a demolding agent, ACMOS 37-7009.

The formulation material was pumped into the mold at 0.5 bars to 1.0 bars of additional pressure by means of a 2-component PU machine available from TARTLER GmbH (product code MVM-5); the machine is a low-pressure machine with a rotating static mixer. The vacuum was applied during the infusion of the formulation in the mold with a high vacuum pump. This experimental setup is typical of LRTM production in which all equipment components (e.g., machine circuits, mold) are at room temperature and are used without temperature control.

The fiber used for all the tests was Owens Corning® Multicore® 300/PP180/300, that is, a glass fiber/polypropylene fleece/glass fiber sandwich material; the use of this reinforcing fiber is common in the art of LRTM. Two sheets of the Owens Corning® Multicore® 300/PP180/300 were used per panel; and the average fiber volume fraction in the composite part was 25 vol %.

The following Table IV summarizes results of the tests. Formulations were chosen among those displaying a time to 1,000 mPa·s around 3 min, an estimated (and visually observed) time for the formulation to completely infuse the glass fiber in the mold. Despite having the same (or even slightly longer) time to 1,000 mPa·s, the Inventive Examples containing a thioglycolate ester-based tin (IV) catalyst demolded much faster than the Comparative Examples. And, the Inventive Examples produced stiffer parts at remarkably high conversion rates.

TABLE IV

| | Comp. Ex. M | Comp. Ex. N | Inv. Ex. 13 |
|---|---|---|---|
| Ingredient | | | |
| Polyol (P1) | 25.00 | 25.00 | 25.00 |
| Polyol (P4) | 11.00 | 11.00 | 11.00 |
| Polyol (P5) | 41.80 | 41.80 | 41.80 |
| TEP | 4.00 | 4.00 | 4.00 |
| DPG | 4.00 | 4.00 | 4.00 |
| Antifoam | 0.20 | 0.20 | 0.20 |
| Water Scavenger | 14.00 | 14.00 | 14.00 |
| Catalyst (C1) | 0.40 | | |
| Additional DPG | | 0.50 | |
| Catalyst (C2) | | 0.50 | |
| TPG | | | 1.35 |
| Catalyst (I1) | | | 0.15 |
| Total Polyol (parts by weight) | 100.4 | 101.0 | 101.5 |
| Property | | | |
| Index | 110 | 110 | 110 |
| Isocyanate (g) | 100.6 | 101.0 | 102.0 |
| Glass Fiber Multicore | 86 | 86 | 86 |
| Fiber Weight Fraction (wt %) | 30 | 30 | 30 |
| time to 10³ mPa · s (s) | 204 | 192 | 240 |
| time to 10⁶ mPa · s (s) | 2236 | 1838 | 593 |
| time to 10⁹ mPa · s (min) | 2 h 10 | 84 | 25 |
| Attempt to demold at time to | Not demoldable | Rubbery at | Stiff |
| 10⁹ mPa · s; appearance | after 130 min; | demolding (84 | |
| | demolded after 150 | min); stiff only | |
| | min; very rubbery at | after 180 min. | |
| | demolding, sample | | |
| | bent/damaged. | | |
| Shore A at demolding | 0 | 70 | >100 |
| | | | (full scale reached) |
| Residual heat of reaction as measured | 68% | 25% | 18% |
| by differential scanning calorimetry | | | |
| (DSC, ramp 25° C.-200° C.) | | | |

What is claimed is:

1. A composition for producing a fiber-reinforced polyurethane composite product comprising:
(I) a polyurethane-forming reactive mixture of:
(a) at least one polyisocyanate;
(b) at least one polyol; and
(c) at least one tin (IV)-based catalyst, wherein the at least one tin (IV)-based catalyst is an alkyl tin (IV) thioglycolate ester catalyst; and
(II) at least one fibrous material;
wherein the viscosity of the composition increases over time such that the ratio of A:B for the composition is less than 4.5; wherein A is the time needed for the composition to reach a viscosity of 10⁶ mPa·s and B is the time needed for the composition to reach a viscosity of 1,000 mPa·s.

2. The composition of claim 1, wherein the at least one polyisocyanate, component (I)(a), is polymeric methylenediphenyldiisocyanate; and wherein the amount of the at least one polyisocyanate provides the composition with an isocyanate index from 80 to 120.

3. The composition of claim 1, wherein the at least one polyol, component (I)(b), is a polyether polyol, a polyester polyol, or a mixture thereof.

4. The composition of claim 1, wherein the at least one thioglycolate ester catalyst, component (I)(c), is an alkyl tin (IV) thioglycolate ester, wherein the alkyl tin (IV) thioglycolate ester includes at least a first alkyl group, wherein the at least first alkyl group of the alkyl tin (IV) thioglycolate ester is directly bonded to the tin (IV) atom of the alkyl tin (IV) thioglycolate ester, and wherein the at least a first alkyl group is an alkyl group having from 1 carbon atom to 10 carbon atoms; and wherein the alkyl tin (IV) thioglycolate ester includes at least a second alkyl group, wherein the at least second alkyl group of the alkyl tin (IV) thioglycolate ester is part of a thioglycolate ester ligand, and wherein the at least second alkyl group is an alkyl group having from 1 carbon atom to 10 carbon atoms.

5. The composition of claim 1, wherein the concentration of the at least one tin (IV)-based thioglycolate ester catalyst, component (I)(c), is from 0.05 weight percent to 0.4 weight percent based on the blend of the at least one polyol, component (I)(b), and the at least one thioglycolate ester catalyst, component (I)(c).

6. The composition of claim 1, wherein the at least one fibrous material, component (II), is a reinforcing fiber selected from the group consisting of glass fiber, carbon fiber, polyolefin-based fiber, and mixtures thereof; and wherein the concentration of the at least one fibrous material, component (II), is from 5 volume percent to 50 volume percent.

7. The composition of claim 6, wherein the polyolefin-based fiber is a polypropylene fiber.

8. A process for producing a composition useful for producing a fiber-reinforced polyurethane composite product comprising mixing:
(I) a polyurethane-forming reactive mixture of:
(a) at least one polyisocyanate;
(b) at least one polyol; and
(c) at least one tin (IV)-based catalyst, wherein the at least one tin (IV)-based catalyst is an alkyl tin (IV) thioglycolate ester catalyst; and
(II) at least one fibrous material;
wherein the viscosity of the composition increases over time such that the ratio of A:B for the composition is less than 4.5; wherein A is the time needed for the composition to reach a viscosity of 10⁶ mPa·s and B is the time needed for the composition to reach a viscosity of 1,000 mPa·s.

9. A process for producing a fiber-reinforced polyurethane composite product comprising: after mixing the components (I) and (II) of the composition of claim 1, allowing the composition to react; wherein upon reaction of the composition, a fiber-reinforced polyurethane composite product is produced.

10. A fiber-reinforced polyurethane composite product produced by the process of claim 9.
